(19) United States
(12) Patent Application Publication
(10) Pub. No.: US 2004/0057228 A1
(43) Pub. Date: Mar. 25, 2004

(54) Light source of LED for scanner

(75) Inventors: Shi-Hua Huang, Taipei (TW); Po-Hua Fang, Yung-Ho City (TW); Hsiu-O Hsu, Hsin-Chu City (TW)

Correspondence Address: LOWE HAUPTMAN GILMAN & BERNER, LLP, Suite 310, 1700 Diagonal Road, Alexandria, VA, 22314, US

(73) Assignee: VEUTRON CORPORATION

(21) Appl. No.: 10/406,496

(22) Filed: Apr. 4, 2003

(30) Foreign Application Priority Data
Sep. 19, 2002 (TW) 091121517

(51) Int. Cl. F21V 33/00

(52) U.S. Cl. 362/89; 362/240; 362/244; 362/800

(57) ABSTRACT

A LED light source used in a scanner is disclosed, and particularly a series of lenses employed to condense the LED light on the front and rear sides and disperse the LED light to the left and right sides. LED compared with CCFL employed as a light source can improve the problem of high power consumption, warm-up, and the limits of lifetime. Furthermore, the light through the lens extends the range of the left and right sides on a scanned material. Therefore, the amount of the LEDs decreases, than that skilled in the art used a large number of LEDs for obtaining a smoother field of light, and achieve low power consumption.

### BACKGROUND OF THE INVENTION

1. Field of the Invention

This invention relates to a scanner with an LED light source and particularly to an LED light source with a condensing lens that condenses the LED light from the front and rear sides and disperses the LED light on the left and right sides.

2. Description of the Prior Art

In general, a scanner utilizes the light source needed for scanning to produce and project the light onto the material to be scanned. The image of the scanned material is then received and transmitted as reflected light from the scanned material. The image is then captured and the data of the captured image is conveyed to a personal computer etc. for processing. The light source used to project the scanned material generally produces a linear light, which the brightness of light remains unchanged during scanning. A large variation of brightness is forbidden to ensure the needed accuracy in the brightness of the captured image. Especially when scanning a colorful image, the light source must be constantly stable white light source, so that the captured image achieves a high quality in brightness, stability of color, and similarity in imaging.

Referring to FIG. 1A and FIG. 1B, the conventional art is using a CCFL 10 (Cold Cathode Fluorescent Lamp) or a linear plurality of a LED light source as the scanning light source. When the CCFL is utilized as a scanning light source, the illumination is isotropic 16. The illumination is a spotlight 14 by a pillar made of a concave surface or a mirror 12, (as shown in FIG. 1A and 1B.) and projected onto the scanned material. In addition, the CCFL 10 must warm-up before becoming stable for use in capturing the image of the material scanned. Furthermore, the lifetime of CCFL 10 is generally about ten thousand hours and produces a large amount of heat and energy due to the low efficiency of CCFL 10 illumination thus wasting a large amount of energy. Therefore, the CCFL 10 has an inherent defect in time and power consumption.

On the other hand, a plurality of LED 22, used as a light source for scanning, broadens the CCFL 10 limitations of life expectancy to an average of about one hundred thousand hours and effectively improves the warm-up duration of the scanning light source. Thus a plurality of LED 22 achieves convenience after turning on a scanner by being able to instantly scan a document. However the physical characteristic of the LED 22 is a forward dispersing and circular light source which the brightness decreases from the center to the edges, as shown in FIG. 2A. Hence, the LED 22 as a scanning light source that is tightly arranged in a line to avoid the inherent physical defects of the LED 22 light sources. Then, a pillar of waveguide assembly is mounted onto the LED 22, in order too converge the LED light in a front and rear direction, as shown in FIG. 2B and FIG. 2C. Hence the light produced by the LED 22 overlap with each other, and the brightness increases to reach the needed scanning light which is bright enough and remain unchanged with time, as shown in FIG. 2D. The LED 22 has a high luminescence efficiency to avoid producing a large amount of heat and energy like the CCFL 10. Nevertheless, a plurality of LED 22 used as a scanning light source causes to reduce inefficiently in the necessary power for illumination.

Hence, in order to achieve lower power consumption, an extended lifetime, and too begin scanning without any warm-up time, it is an important object to provide a needed light source for scanning.

### SUMMARY OF THE INVENTION

The conventional arts mentioned above, can't provide a scanning light source with a lower power consumption, longer lifetime, and to begin scanning without any warm-up time. In accordance with the present invention, the front and rear sides of the LEDs light is condensed by lenses to increase the brightness and the light of the left and right sides thereof is simultaneously dispersed to form a linear light source. For this reason, the amount of LEDs is efficiently reduced.

It is another object of this invention to efficiently decrease the amount of the LEDs needed by utilizing lenses to condense the LEDs light in the front and rear, and disperse the LED light on the left and right sides.

It is a still another object of this present invention to reduce the cost price of LEDs by utilizing lenses that condense the LEDs light on the front and rear sides, and then disperse the LEDs light on the left and right sides.

It is another object of this invention to provide a scanning light source by using LEDs with a longer lifetime, and decreasing the limits of a scanner due to the scanning light source.

It is a still another object of this present invention to provide an LED scanning light source that has the advantage of scanning without time allotted for warm-up, thus increasing efficiency in scanning time.

It is another object of this invention to form a plane light source on the light field corresponding to the different needs, by utilizing lenses that condense the LED light on the front and rear sides and then disperse the LED light on the left and right side.

In accordance with the above-mentioned objects, the present invention provides a lens assembly that condenses the LED light for the front and rear sides, then disperses the LED light on the left and right side, and a method for manufacturing the same. The present invention employs a lens assembly for condensing the light in the front and rear side and dispersing the light on the left and right sides. Hence, this prevent invention decreases the limit of a scanners lifetime, and provides a scanning light source without the need to warm-up thus preventing the waste of time. Furthermore, the lens assembly is employed to increase brightness by condensing the light on the front and rear side, and broadening the range of illumination on the left and right sides to arrange the LEDs loosely. For this reason, the needed distance of each LEDs is broadened. In the same scanning width, the needed amount of LEDs can be decreased, the cost of the LEDs can be reduced, and further the power consumption of the scanning light source can be substantially decreased.

### BRIEF DESCRIPTION OF THE DRAWINGS

The foregoing aspects and many of the attendant advantages of this invention will become more readily appreciated as the same becomes better understand by reference to the following detailed description, when taken in conjunction with the accompanying drawings, where in:

FIG. 1A is a top view of a CCFL scanning light source;

FIG. 1B is a side view of a CCFL scanning light source;

FIG. 2A is a diagram of brightness varies with position in a plane perpendicular to illuminating direction of LED;

FIG. 2B is a top view of LEDs as a scanning light source in those conventional arts;

FIG. 2C is a side view of LEDs as a scanning light source in those conventional arts;

FIG. 2D is a diagram of brightness of LEDs as a scanning light source varies with position perpendicular to illuminating direction of LED in those conventional arts;

FIG. 3A is a top view of the related position of a white light LED mounted on a printed circuit board;

FIG. 3B is a side view of the related position of a white light LED mounted on a printed circuit board;

FIG. 3C is a diagram of power terminal and ground terminal of a LED connect with power supply controlled by ASIC;

FIG. 4A is a top view of a circular cylinder;

FIG. 4B is a cross-sectional view of a circular cylinder taken along line 4B-4B of FIG. 4A;

FIG. 4C is a diagram of a symmetrical saddle-shaped lens;

FIG. 4D is a top view of a symmetrical saddle-shaped lens;

FIG. 4E is a cross-sectional view of the center of the symmetrical saddle-shaped lens taken along 4E-4E of FIG. 4D before amend thickness;

FIG. 4F is a cross-sectional view of the center of the symmetrical saddle-shaped lens taken along 4E-4E of FIG. 4D after amended thickness;

FIG. 4G is a side view of the symmetrical saddle-shaped lens before amend thickness;

FIG. 4H is a side view of the saddle-shaped lens after amended thickness;

FIG. 4I is a side view of the symmetrical saddle-shaped lens with the plurality triangle cone protruding nicks;

FIG. 4J is a top view of the symmetrical saddle-shaped lens with the plurality triangle cone protruding nicks;

FIG. 4K is a side view of the symmetrical saddle-shaped lens with the plurality triangle cone protruding nicks;

FIG. 4L is a diagram of a light passing through the bottom protruding nicks of the symmetrical saddle-shaped lens with the plurality triangle cone protruding nicks;

FIG. 5A is a foot view of the symmetrical saddle-shaped lens with four thin cylinders mounted on four edges of the symmetrical saddle-shaped lens;

FIG. 5B is a side view of the symmetrical saddle-shaped lens with four thin cylinders mounted on four edges of the symmetrical saddle-shaped lens;

FIG. 5C is a side view of the symmetrical saddle-shaped lens with four thin cylinders mounted on four edges of the symmetrical saddle-shaped lens which is mounted on a printed circuit board;

FIG. 5D is a top view of the symmetrical saddle-shaped lens with four thin cylinders mounted on four edges of the symmetrical saddle-shaped lens which is mounted on a printed circuit board;

FIG. 6A is a diagram of the light field of the light of a LED through a waveguide pillar and through a saddle-shaped lens;

FIG. 6B is a diagram of the overlapping light field of a plurality of LEDs through a waveguide pillar and through a saddle-shaped lens;

FIG. 7A is a top view of the related position of RGB LED mounted on a printed circuit board;

FIG. 7B is a diagram of power terminal and ground terminal of RGB LED connected with power-supply which controlled by ASIC; and

FIG. 8A to FIG. 8D is a diagram with different arrangement of LEDs respectively.

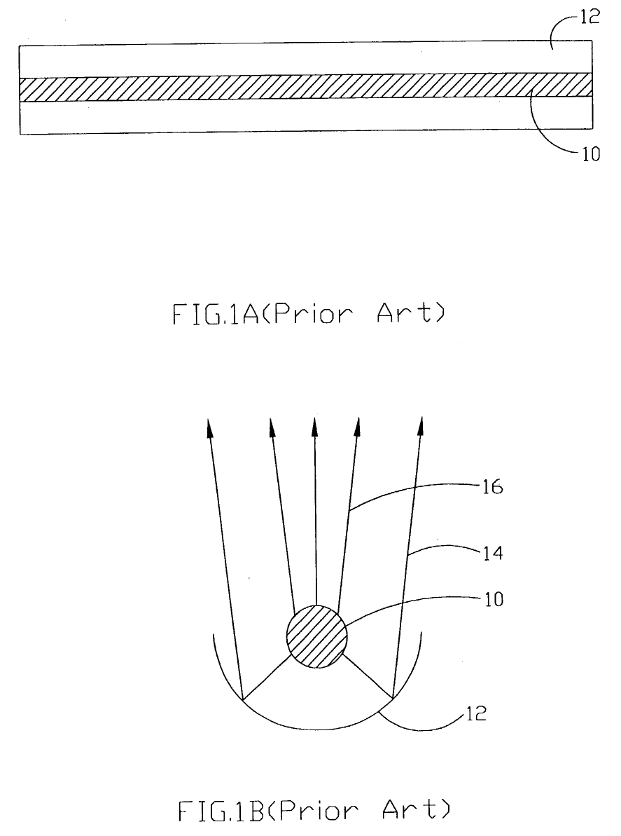

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

Then, the components of the different elements of the scanning light source are not shown to scale. Some dimensions are exaggerated so that the related components and meaningless portions are drawn to provide a more clear description and comprehension of the present invention.

First, a direction of left and right sides of LED is along a direction of a line of LEDs and a direction of front and rear sides thereof is perpendicular to a direction of a line of LEDs.

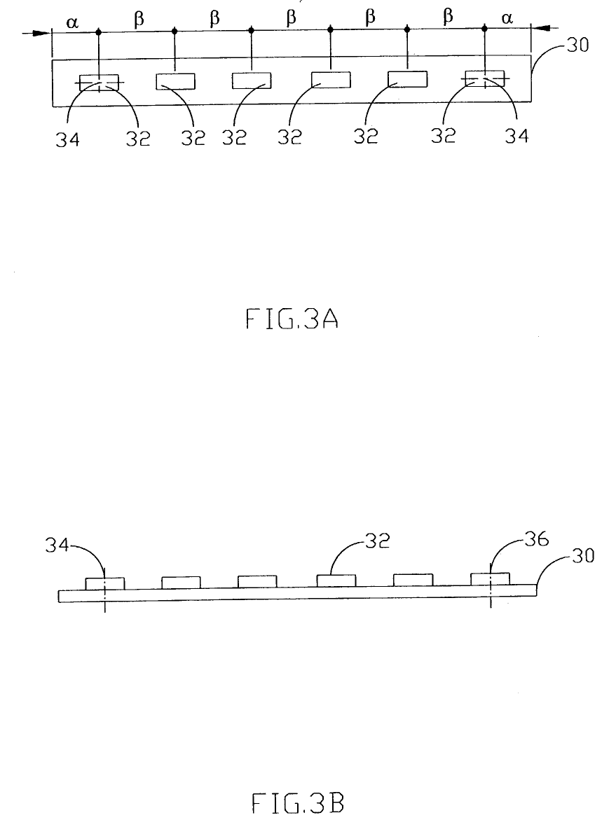

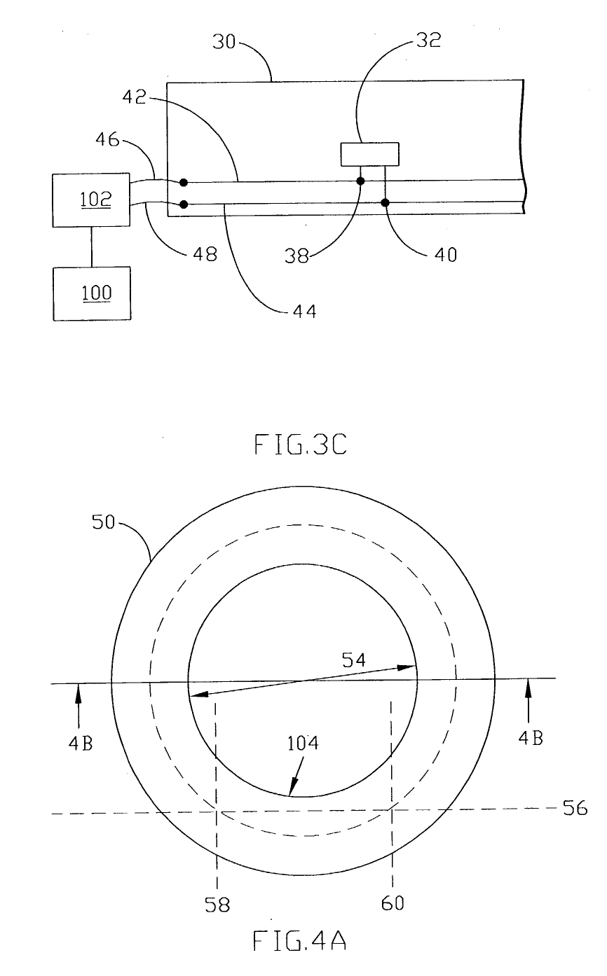

Referring to FIG. 3A and FIG. 3B, one preferred embodiment of this invention employs a bar printed circuit board (PCB) 30, the length of the PCB is greater than about 216 mm and the width of the PCB is greater than about 2 mm. Due to the lack of white Light Emitting Diode (LED) of a most left white LED 32 at the left side, and a most right white LED 32 at the right side, the attenuation of brightness with a distance from the white LED 32 is greater in two sides of filed of the LED light. Therefore, the distance a between the left (or right)end of PCB 30 and the most left (or right) white LED 32 must be shorter than a half of distance 8 between the white LED 32 each other. In this present invention, a white LED 32 is mounted at a position 34 that is about 8 mm away from the left end of PCB 30, and others is mounted at the PCB 30 by an interval of about 40 mm until a position 36 that is about 8 mm away from the right end of PCB 30. Consequently, total of six white LED 32 is mounted in the PCB 30. A parallel circuit 42, 44 is arranged in the PCB 30 for connecting respectively all power terminal 38 and ground terminal 40 of white LED 32, as shown in FIG. 3C. Then, a conducting wire 46, 48 connects the parallel circuit 42, 44 that connects respectively all power terminals 38 and ground terminals 40 of total white LED 32 to a power supply 102 for controlling the brightness of white LED 32.

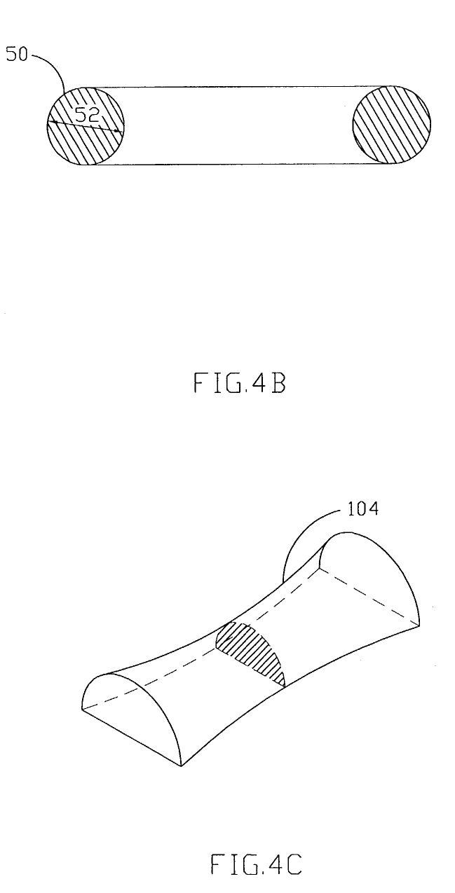

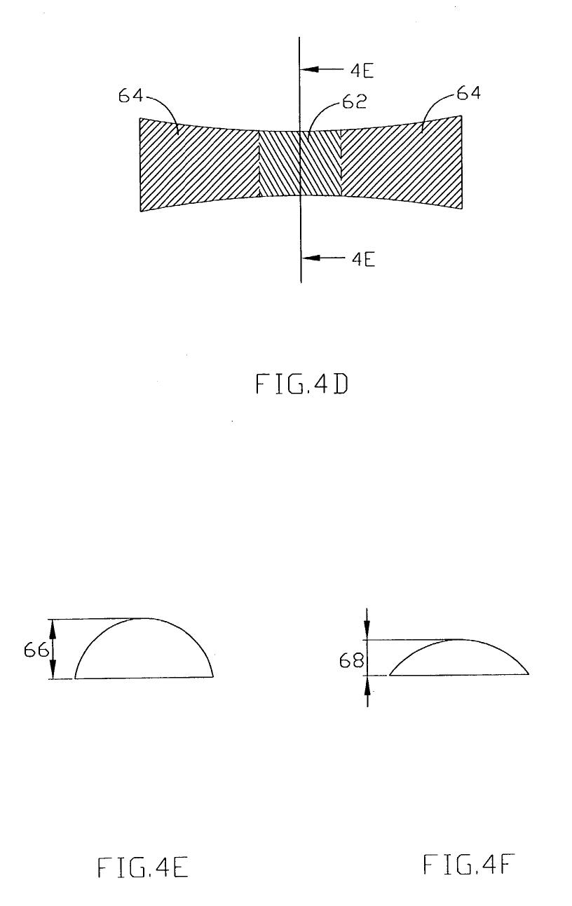

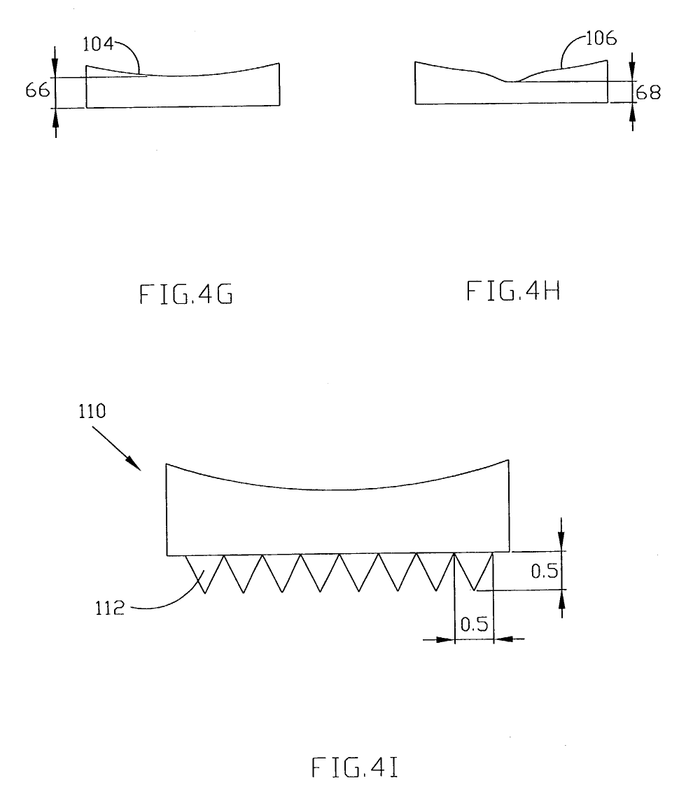

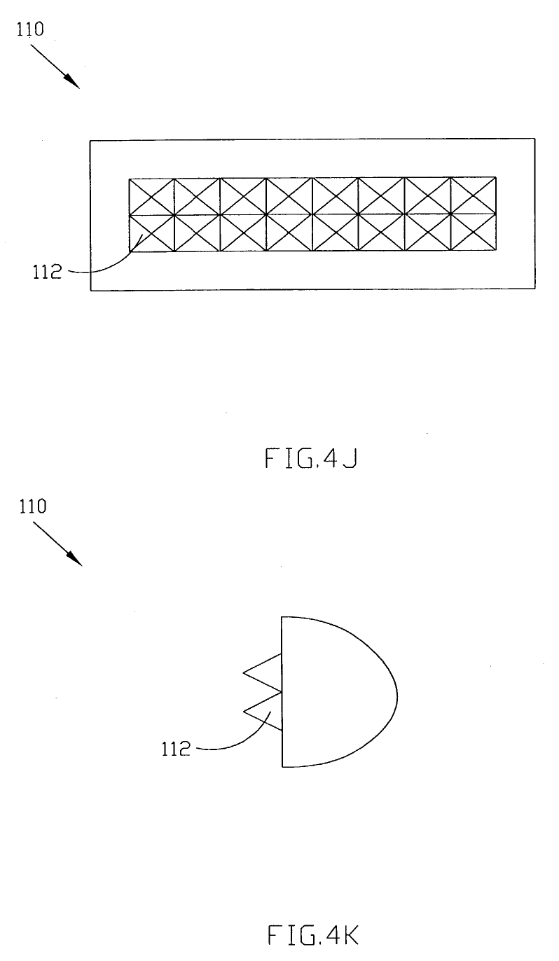

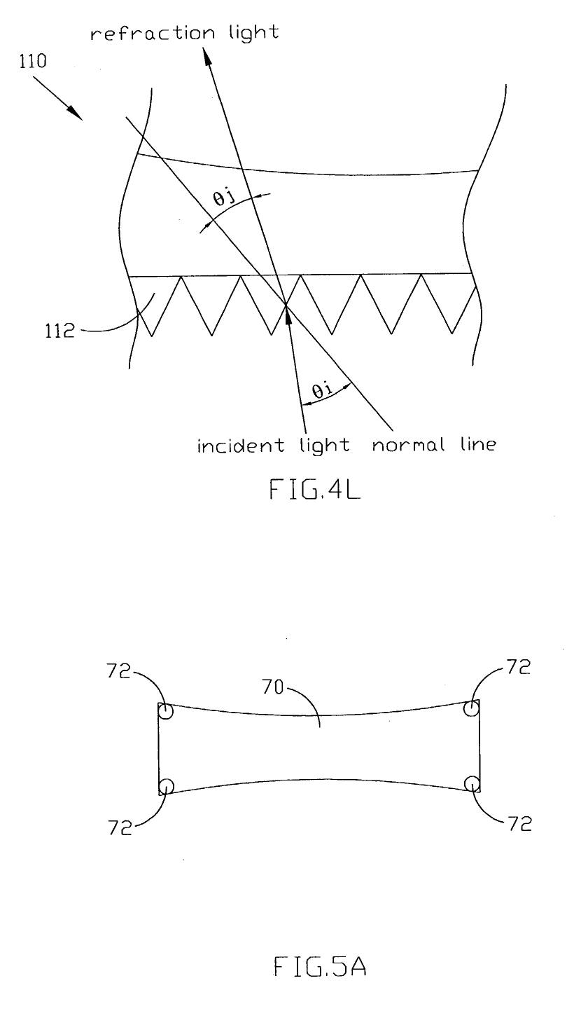

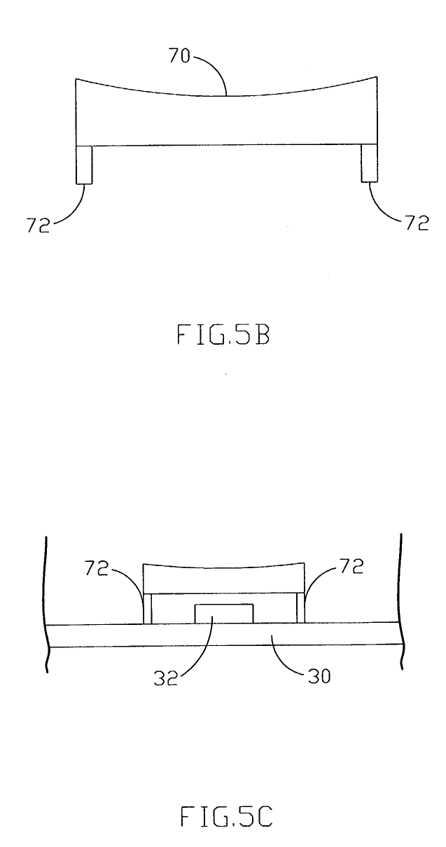

A ring like cylinder is selected from the group consisting of PMMA (Methacrylic resin) and PC (Polysulfone), that the diameter of cylinder 52 is about 6 mm and the inner diameter of the ring 54 is about 18 mm, as shown in FIG. 4A and FIG. 4B. A symmetrical shape of a saddle lens is obtained by cutting along the cutting line 56, 58, and 60. The crossed-section of the symmetrical shape of a saddle lens 104 is an arc. The thickness of the central portion thereof is about 0.9 to 3 mm, the thickness of two edges thereof is about 3 to 6 mm and the length thereof is about 6 to 12 mm, and the bottom and two edges thereof are plane surfaces, as shown in FIG. 4C.

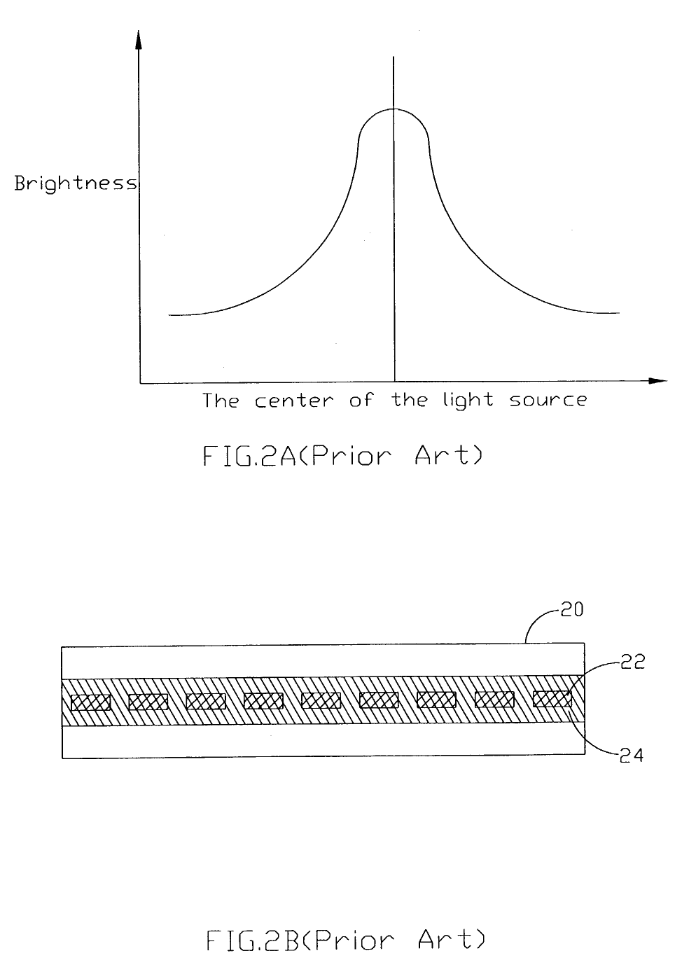

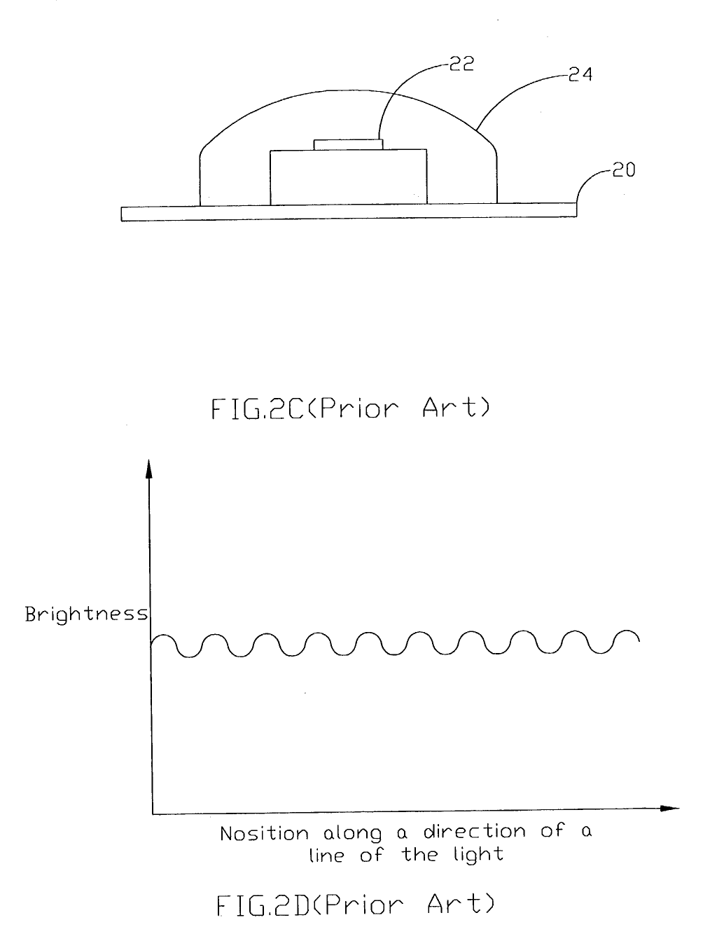

Referring to FIG. 2A, the characteristics of an LED light is a circular light source that forwardly emits light, which the brightness thereof decreases progressively outward. The LED light converts to a linear light source as required by a scanning light source with the symmetrical shape of a saddle lens 104 that condenses the LED light from the front and rear sides and disperses the LED light on the left and right sides. Furthermore, the profile of the symmetrical shape of a saddle lens 104 is narrower in central portion 62 and wider in two edge portions 64, as shown in FIG. 4D. Therefore, the converging area of the central portion 62 of light is smaller than the converging area of two edge portions 64, and the difference of brightness between the central portion of light and two edge portions of light is reduced. Thus, it provides a more proper scanning light source.

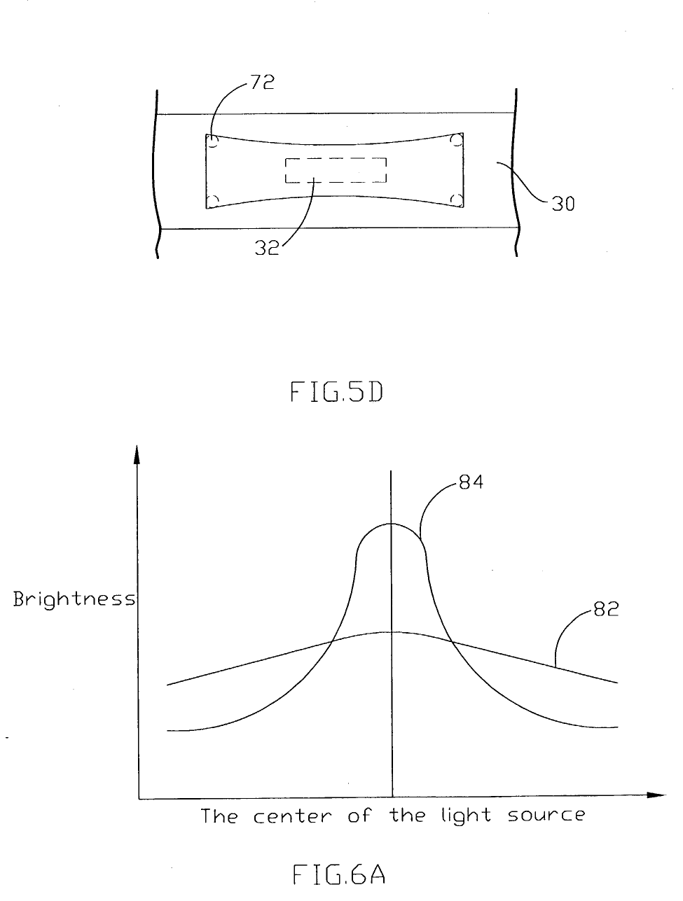

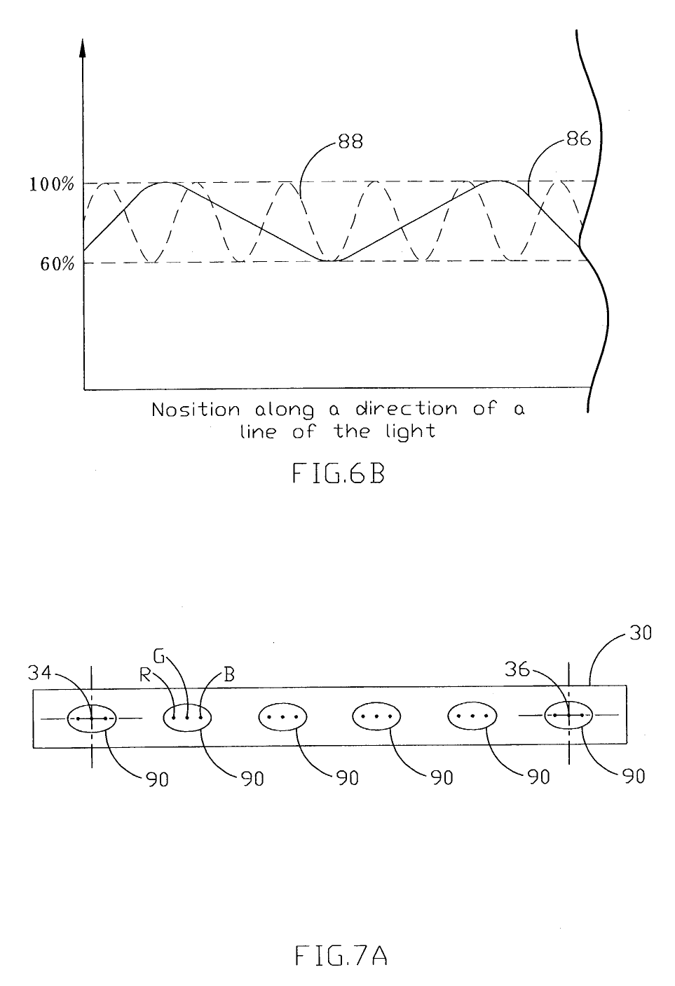

Four thin columns 72, with a diameter about 2 mm, are mounted on the four corners of the bottom of plate 70 of the symmetrical shape of a saddle lens 104, as shown in FIG. 5A and FIG. 5B. Then, the symmetrical shape of a saddle lens 104 that four thin columns 72 have been mounted thereon is mounted on the PCB 30 upon a corresponding white LED 32 as center. In this manner, each white LED 32 is one-to-one with each symmetrical shape of the saddle lens 104 without contact or protection from an uneven PCB, as shown in FIG. 5C and FIG. 5D. Thus, the field of LED light 82 through the symmetrical shape of a saddle lens 104 is smoother than the field of LED light 84 through a pillar of waveguide assembled in the direction of left and right, as shown in FIG. 6A. On the premise that the lowest brightness of the scanning light source is larger than 60% of the highest brightness, the necessary amount of LED overlapping light field 86 with a symmetrical shape of a saddle lens 104 is less than the necessary amount of LED of overlapping light field 88 with a pillar of waveguide assembly, as shown in FIG. 6B.

The difference of brightness between the center and edge of the field of light is further reduced by and emended by the curvature of the center and edge of the symmetrical shape of a saddle lens 104. The central portion 62 of the symmetrical shape of a saddle lens 104 is polished thin to reduce the curvature of the central portion 62 in the direction of front and rear. So the efficiency of the converging light of the central portion 62 is weaker than at the edge, as shown in FIG. 4E and FIG. 4F. Furthermore, the curvature of the central portion 62 in the direction of the left and right is increased simultaneously by the above-mentioned polishing process, and so the efficiency of the dispersing light of the central portion 62 is stronger than at the edge, as shown in FIG. 4G and FIG. 4H. By reducing the efficiency of the converging light of the central portion 62 in the front and rear direction, and increasing the efficiency of the dispersing light of the central portion 62 in a left and right direction, the whole efficiency of the converging light of the central portion 62 is weaker than the edge portions 64. In this manner, the difference of brightness between the center and the edge of the field of light through an emended shape of a saddle lens 106 reduces further.

Furthermore, a preferred embodiment of the saddle lens is the saddle lens 10 with plurality triangle cone protruding nicks 112. In a preferred embodiment, the height of the triangle cone protruding nicks 112 is 0.5 mm (mini-meter), and the bottom area is 0.5 mm (mini-meter)×0.5 mm ( mini-meter), as shown in FIG. 41. FIG. 4J is a top view of the symmetrical saddle-shaped lens 110 with the plurality triangle cone protruding nicks 112. FIG. 4K is a side view of the symmetrical saddle-shaped lens 110 with the plurality triangle cone protruding nicks 112.

As the above mentioned, the characteristic of the LED light is a circular light source, as well as emits forwardly, and the brightness thereof decreases progressively outward. The LED light converts to a linear light source that fits to be a scanning light source by the symmetrical shape of a saddle lens that condenses the light of the LEDs for front and rear sides and disperses the light of the LEDs on left and right sides. Furthermore, the profile of the symmetrical shape of a saddle lens is narrower in central portion and wider in two edge portions. Therefore, the converging area of light of the central portion is smaller than the converging area of two edge portions, and the difference of brightness between the central portion of light and two edge portions of light reduces. In a light passing through the bottom protruding nicks 112 of the symmetrical saddle-shaped lens 110 with the plurality triangle cone protruding nicks 112, the incident angle θᵢ diverges the refraction angle θⱼ with the light refraction, thereby the difference of brightness between the central portion of light and two edge portions of light reduces greatly, as shown in FIG. 4L. Thus, the saddle lens 110 with plurality triangle cone protruding nicks 112 provides more proper scanning light source.

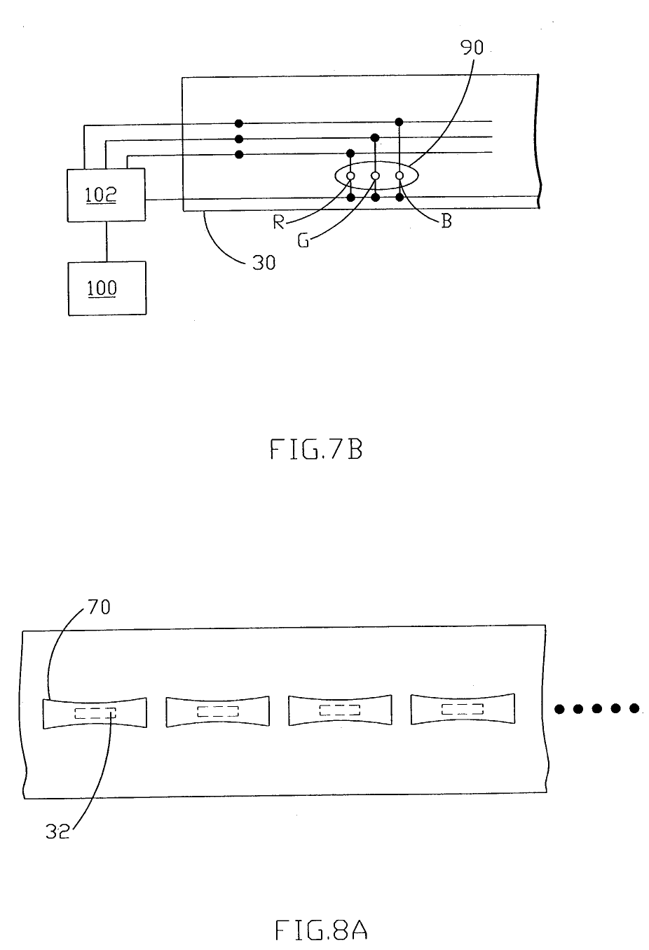

Another preferred embodiment according to this present invention replaces the above-mentioned white LED 32 with a RGB mixture-light LED 90 to mount at position 34, about 8 mm away from the left end of PCB 30. Others are mounted at the PCB 30 by an interval of about 40 mm until a position 36 is about 8 mm away from the right end of PCB 30, as shown in FIG. 7A. The power terminal and ground terminal of the RGB mixture-light LED 90 are connected to the power supply 102 respectively, for supplying a needed power of the RGB mixture-light LED 90. An ASIC (Application Specific Integrated Circuit) 100 is employed to connect with the power supply 102 for controlling the brightness of each color of the RGB mixture-light LED 90 to provide single color or other mixed color, as shown in FIG. 7B. Four thin columns 72 are mounted on the four corners of the bottom plate 70 of lens 104 or 106. Then, the symmetrical shape of a saddle lens 104 or the emended shape of a saddle lens 106 is mounted on PCB 30 upon the RGB mixture-light LED 90 as center by four thin columns 72 and without contact. The light of the RGB mixture-light LED 90 is fixed to a linear field of light and mixed with a white light or other colors of demand.

The type of LED in this present invention is unlimited to the white LED or the RGB mixture-light LED, and can be any mixture or type of LED as demanded.

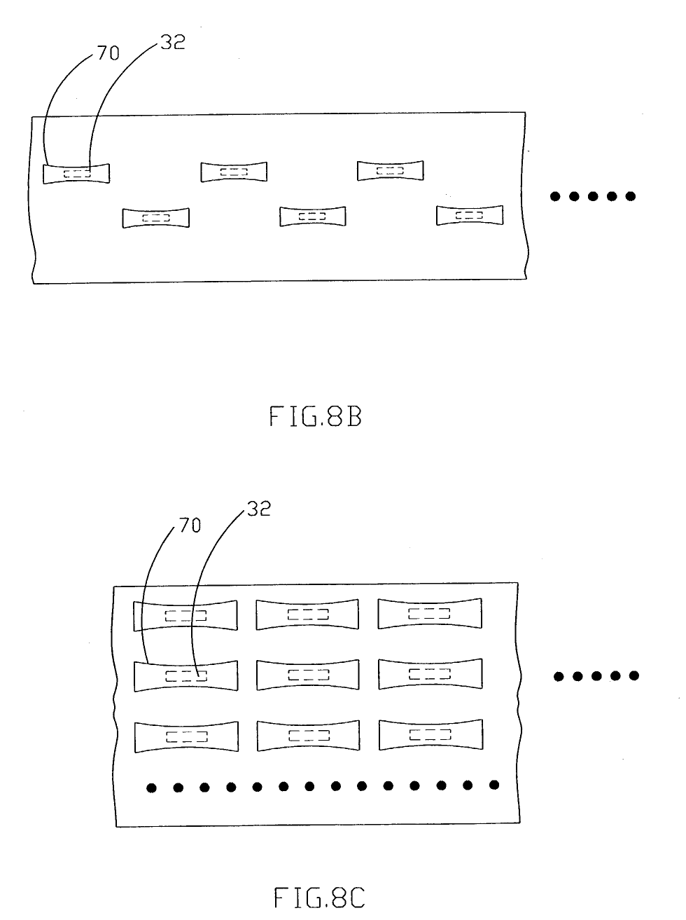

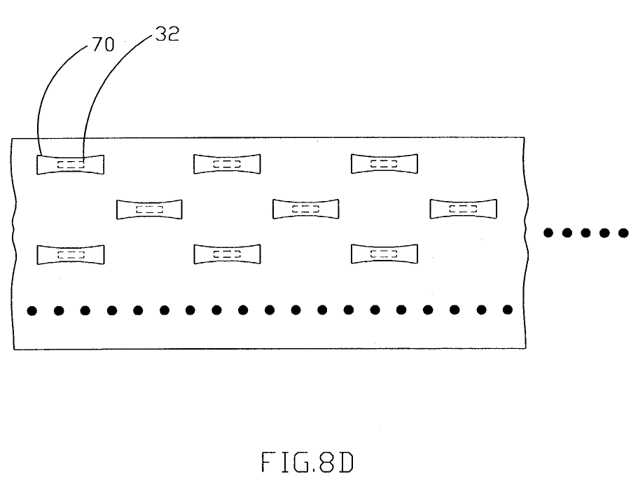

The arrangement of the module of LEDs in this present invention is not only a line, as shown in FIG. 8A, but also sideways arrangement of two lines of LEDs, a matrix, a crisscross matrix, and so on, as shown in FIG. 8B to FIG. 8D. The FIG. 8D shows a sideways matrix that the LEDs are arranged at 45-degree angles, but it is not limit the arrangement of the LEDs at 45-degree angles, and the the LEDs are arranged at any angles of demand. That is to say, the distance between a LED of a line of the LEDs and a first nearest LED of a adjacent line may be not equal to the distance between the LED of the line of the LEDs and a second nearest LED of the adjacent line. Therefore, the different arrangement of the LEDs can provide a light source with a different shape of demand.

According to the preferred embodiments, this invention discloses a plurality of lenses employed to condense the front and rear side of LED light and disperse the LED light on the left and right side as used in a scanner. The above-mentioned scanning light source that compares with CCFL can improve the warm-up problem and the limited lifetime to increase the efficiency in time and decreasing the limit of the lifetime of the scanner. Furthermore, the field of light through the above-mentioned lens is fixed to a linear field of light and reduces the difference of brightness between the central portion and the edge portion of light. Hence, compared with using a pillar of waveguide assembly in the conventional art, this present invention provides a preferred scanning light source and decreases the necessary amount of LED to reduce the cost price of the LEDs. For example, the power of a LED is about 0.15 Watts, and so the total power of LED in this preferred embodiment is about 0.90 Watts. Hence total power of the LED in this preferred embodiment is less than 3 to 6 Watts of CCFL. In comparison to the conventional art the preferred embodiment archives low power consumption.

Although specific embodiments have been illustrated and described, it will be obvious to those conventional art that various modifications may be made without departing from what is intended to be limited solely by the appended claims.

What is claimed is:

1. A light source of LED used in a scanner, comprising:
a plurality of LED arranged for providing a light source for scanner; and
a plurality of lens mounted one-on-one upon said light source of LED to disperse the light of LED in a first direction and condense the light of LED in a second direction for fixing the field of light of LED, wherein said first direction is along a direction of said line of LEDs and said second direction is perpendicular to said line of LEDs.

2. The light source of LED used in a scanner according to claim 1, wherein said LED comprises a plurality of RGB mixture-light LED.

3. The light source of LED used in a scanner according to claim 2, wherein said LED comprises a plurality of white LED.

4. The light source of LED used in a scanner according to claim 3, wherein the brightness of said LED is controlled by a ASIC.

5. The light source of LED used in a scanner according to claim 1, wherein said LED comprises a plurality of white LED.

6. The light source of LED used in a scanner according to claim 5, wherein the brightness of said LED is controlled by a ASIC.

7. The light source of LED used in a scanner according to claim 1, wherein said lens is a shape of a saddle lens.

8. The light source of LED used in a scanner according to claim 7, wherein the bottom of said saddle-shaped lens has a plurality triangle cone protruding nicks.

9. The light source of LED used in a scanner according to claim 8, wherein the height of the triangle cone protruding nicks is 0.5 mm (mini-meter), and the bottom area is 0.5 mm (mini-meter)×0.5 mm (mini-meter).

10. The light source of LED used in a scanner according to claim 7, wherein said lens is an emended shape of a saddle lens that the efficiency of converging light of the central portion of a lens is weaker than the edge portion thereof in said second direction, and the efficiency of dispersing light of the central portion thereof is stronger than the edge portion thereof in said first direction.

11. The light source of LED used in a scanner according to claim 1, wherein said lens is selected from PMMA.

12. The light source of LED used in a scanner according to claim 1, wherein said lens is selected from PC.

13. The light source of LED used in a scanner according to claim 1, wherein said a plurality of LED are arranged in said first direction.

14. The light source of LED used in a scanner according to claim 1, wherein said a plurality of LED are arranged in sideways two lines in said first direction.

15. The light source of LED used in a scanner according to claim 1, wherein said a plurality of LED are arranged in a matrix.

16. The light source of LED used in a scanner according to claim 1, wherein said a plurality of LED are arranged in a sideways matrix.

17. The light source of LED used in a scanner according to claim 1, wherein said lens is that a curvature of a central portion of said lens in said first direction or second direction may differ with or as same as a curvature of two edge portions thereof.
